(19) United States
(12) Patent Application Publication
(10) Pub. No.: US 2025/0102043 A1
(43) Pub. Date: Mar. 27, 2025

(54) DAMPER VALVE AND VIBRATION DAMPER

(71) Applicants: thyssenkrupp Bilstein GmbH, Ennepetal (DE); thyssenkrupp AG, Essen (DE)

(72) Inventor: Martin FLICK, Gummersbach (DE)

(73) Assignees: thyssenkrupp Bilstein GmbH, Ennepetal (DE); thyssenkrupp AG, Essen (DE)

(21) Appl. No.: 18/891,361

(22) Filed: Sep. 20, 2024

(30) Foreign Application Priority Data
Sep. 25, 2023 (DE) 10 2023 125 838.9

(51) Int. Cl. F16F 9/516; B60G 13/08; B60G 17/08; F16F 9/19; F16F 9/348; F16F 9/44

(52) U.S. Cl. CPC F16F 9/516; B60G 13/08; B60G 17/08; F16F 9/19; F16F 9/3484; F16F 9/44; B60G 2202/24; B60G 2204/61; B60G 2206/41; B60G 2300/27; B60G 2500/11; B60G 2600/20; B60G 2600/21; B60G 2800/162; B60G 2800/916; F16F 2222/12; F16F 2228/066; F16F 2230/186; F16F 2230/36

(57) ABSTRACT

A damper valve for a vibration damper, in particular of a motorized vehicle, comprises a valve body, at least one control disc arranged on the valve body and at least one rotatably mounted adjustment element, wherein the valve body, the control disc and the adjustment element are arranged coaxially, wherein the control disc is connected to the adjustment element for conjoint rotation and the control disc is rotatable relative to the valve body in order to open up at least one of a plurality of through-channels in the valve body for the flow of a damper fluid or to block the flow, wherein the valve body has a plurality of recesses with different opening areas which are covered by at least one valve disc, wherein in each case one through-channel leads into in each case one of the recesses.

### CROSS REFERENCE TO RELATED APPLICATION

This application is a U.S. Non-Provisional that claims priority to German Patent Application No. DE 10 2023 125 838.9, filed Sep. 25, 2023, the entire content of which is incorporated herein by reference.

### FIELD

The present disclosure relates to a damper valve and to a vibration damper.

### BACKGROUND

Precise and easy regulation of the damping force is important in particular in the motorsports sector. There, shock absorbers with a variable damping force usually have switchable valve devices with which, for example, connecting channels in the piston can be opened or closed in order to change the damping force.

JP 2012 145 171 A mentioned at the beginning discloses, for example, a vibration damper having a settable damping force, wherein the setting takes place via an adjustable piston valve. The piston valve has a plurality of valve discs arranged one above another, wherein each one has two integrated flexible sheet-metal tongues. The sheet-metal tongues of the valve discs lie one above another in a stepped manner. The valve discs form a disc packet, which is rotatable jointly about the piston rod longitudinal axis. The rotation of the disc packet takes place in an actuating element which is arranged in the piston rod and which is rotatable from the outside by an operator. During the setting of the damping force, the spring characteristic of the disc packet is changed in that the projecting length of the sheet-metal tongues in the piston is lengthened or shortened. A drawback here is that the vibration damper for adjusting the damping force has a complex structure and is thus costly.

A further vibration damper having an adjustable piston valve is known, for example, from KR 2017 068 300 A.

Also known from the prior art are settable valves for setting a damping force, in which spring disc packets are used, which are pretensioned by a spring. As a result of the pretensioning force of the spring, different opening pressures can be set. It is known that the pretensioning of the spring disc packets is so high that actuation by an operator, i.e. by hand, is not possible. In particular, this results in the drawback that setting losses can arise, which influence the spring pretensioning. In addition, such a valve unit has an increased overall size and an increased weight. A further drawback is that, upon adaptation of the spring disc plating, the characteristic with which the characteristic curve can be adjusted by the spring tensioning changes.

Some embodiments include a damper valve for a vibration damper, which, as a result of an improved structure, allows easy and precise setting of the damping force of a vibration damper. Some embodiments include a vibration damper having such a damper valve.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a longitudinal section through a vibration damper having two damper valves according to one exemplary embodiment.

FIG. 2 shows a longitudinal section through one of the damper valves according to FIG. 1.

FIG. 3 shows a plan view of a control disc of the damper valve according to FIG. 2, wherein the openings in the control disc are clearly visible.

FIGS. 4-13 show a plan view of a valve body of the damper valve according to FIG. 2, wherein a control disc arranged on the rear side is illustrated in different rotational positions.

### DETAILED DESCRIPTION

Some embodiments include a damper valve for a vibration damper, in particular of a motor vehicle, having a valve body, at least one control disc arranged on the valve body and at least one rotatably mounted adjustment element, wherein the valve body, the control disc and the adjustment element are arranged coaxially. The control disc is connected to the adjustment element for conjoint rotation and is rotatable relative to the valve body in order to open up at least one of a plurality of through-channels in the valve body for the flow of a damper fluid or to block the flow. The valve body has a plurality of recesses with different opening areas which are covered by at least one valve disc, wherein in each case one through-channel leads into in each case one of the recesses.

In some embodiments, as a result of the control disc being rotated, a multiplicity of interconnections of the through-channels with the recesses in the valve body is able to be realized. Since the recesses has opening areas with different sizes, it is possible, by rotating the control disc, to increase or reduce a total opening area of the valve body for opening the valve disc. Since the valve disc covers the opening areas of the recesses, a change in the total opening area brings about an adaptation of the size of the pressurized area of the valve disc. As a result of the damper valve described herein, the damping force is thus easily and precisely settable in order to realize softer or harder damping of a vibration damper in line with demand.

Some embodiments have the further advantage that actuation of the control disc by an operator, i.e. by hand, is possible, since, in contrast to what is known from the prior art, the actuation does not takes place counter to the pretensioning force of a spring but rather the control disc is rotated via the adjustment element. Furthermore, the necessary opening force and thus the damping force remain uninfluenced by any setting losses. In addition, the damper valve described herein is able to be produced with a smaller overall size and with a reduced weight.

The greater the number of through-channels that are opened up by the control disc, the greater the number of recesses in which the pressurized damper fluid flows such that the damper fluid is in contact, via the opening areas of the recesses, with the pressurizable area of the valve disc. In other words, the size of the total opening area increases with the increasing number of through-channels, opened up by the control disc, into the recesses. As a result of the larger pressurized area of the valve disc, the valve disc lifts off even with a low fluid pressure such that the damper fluid can pass through. In this way, soft or softer damping of the vibration damper is realized.

The smaller the number of through-channels that are opened up by the control disc, the smaller the number of recesses in which the pressurized damper fluid flows such that the damper fluid is in contact, via the opening areas of the recesses, with the pressurizable area of the valve disc. As a result of the smaller pressurized area of the valve disc, the valve disc lifts off only with an increased fluid pressure such that the damper fluid can pass through. In this way, hard or harder damping of the vibration damper is realized. Alternatively, it is possible for the control disc to block all the through-channels. In this state, the total opening area is equal to zero, and so no damper fluid can pass through the valve body. In other words, in this state, the flow of the damper fluid through the through-channels and thus via the valve disc is completely blocked.

Preferably, the control disc is rotatable incrementally, in particular in steps, by the adjustment element in order to increase or reduce the total opening area. In other words, it is advantageous when the adjustment of the damping force takes place in equal steps. To that end, the control disc is rotatable relative to the valve body by the adjustment element. In other words, the control disc is advantageously actuable via the adjustment element. In this case, the rotation of the control disc is able to be carried out in equal steps with the aid of the adjustment element. This allows easy and precise, in particular reproducible, setting of the damping force of a vibration damper.

The total opening area corresponds to the sum of all the opening areas of those recesses that are fluidically connected to the associated through-channel, in particular opened up, by the control disc. The pressurized area of the valve disc corresponds preferably to the opening area of the recess arranged opposite in each case.

The total opening area may be formed for example by an opening area of a single recess. Alternatively, the total opening area may comprise the opening areas of a plurality of, in particular of at least two, recesses. Preferably, the total opening area comprises the opening areas of at least three recesses, particularly preferably of at least four recesses.

The opening areas should be understood as being those areas which span the recesses at their fluid outlet side. The opening areas are covered by the valve disc. This means that the opening areas face the valve disc. The opening areas therefore form extensive openings of the recesses, which are spanned by the valve disc.

The recesses are preferably formed in a pocket-like manner in the valve body. In other words, the recesses are preferably cutouts which are open towards the valve disc via their opening area on one side and into which in each case one of the through-channels leads on the other side.

The adaptation of the total opening area comprises, within the meaning of the present disclosure, both complete closure of the through-channels, in the case of which no damper fluid passes through the through-channels, and complete opening of the through-channels, in the case of which the damper fluid passes, unimpeded, through all the through-channels. Furthermore, the control disc is designed to take up any desired intermediate position between complete opening or complete closure of the through-channels. To that end, the control disc is rotatable by the adjustment element about the common axis of rotation thereof.

It is particularly advantageous that the damper valve allows the bypass flow in a vibration damper to be regulated or damped. In combination with a vibration damper, the damper valve is preferably provided to allow the damper fluid to flow between the working spaces of the vibration damper which are separated from one another by a working piston, bypassing a piston valve of the working piston. In other words, a bypass fluidic connection can be created, through which a partial flow of the damper fluid through the damper valve is guided past the piston valve. This is, for example, dependent on a rebound stage or pressure stage of the vibration damper.

It is also advantageous that the damper valve allows complete closure of the bypass. This is achievable when all the through-channels are blocked by the control disc and consequently the bypass flow or the partial flow of the damper fluid through the damper valve is substantially equal to zero.

Preferably, the damper valve is used on a vibration damper of a motor vehicle. The damper valve is suitable for damping the rebound stage or pressure stage of a vibration damper. Particularly preferably, the damper valve is used on vibration dampers for racing, since the damper valve allows incremental adaptation of the damping force and thus the damping can be adapted exactly to the track characteristics or the driving style, etc. It is often necessary to cautiously approach the optimal setup, this being allowed by the damping valve as described herein. Some embodiments are not limited to use on vibration dampers for racing. Other areas of application are possible.

In a particularly preferred embodiment, the through-channels in the valve body are able to be selected and/or blocked by the control disc in such a way that, in at least one direction of rotation of the control disc, the opening areas of the recesses are added together or subtracted from one another. This should preferably be understood as meaning that a rotation of the control disc in the clockwise or anticlockwise direction results in particular through-channels in the valve body being opened up or blocked. The factor by which the opening area changes in one direction of rotation of the control disc can in this case be different from one rotational position to the next.

In this case, the adding together of the opening areas of the recesses advantageously results in softer damping. As a result of the opening areas of the recesses being subtracted from one another, harder damping is settable.

In a preferred embodiment, the control disc has a plurality of openings for each through-channel in the valve body, wherein, depending on a rotational position of the control disc, one or more of the through-channels are opened up by the openings or the control disc blocks the through-channels. The control disc preferably forms a central switching disc with a multiplicity of switching openings. The control disc has, as a result, a structure that is as simple as possible, and has increased failure safety.

In a further preferred embodiment, the openings in the control disc and/or the through-channels in the valve body are arranged on different hole circles. Particularly preferably, the control disc and the valve body comprise the same hole circles. The control disc and/or the valve body may have two or three hole circles. It is particularly advantageous when the control disc and/or the valve body have four hole circles. The openings in the control disc and through-channels in the valve body are arranged in an improved structured manner as a result, such that a compact overall size of the damper valve is able to be realized.

It is preferred when the openings in the control disc and the through-channel in the valve body which lie on the same hole circle correspond or are spaced apart from one another depending on the rotational position of the control disc. If the openings are spaced apart from the through-channels, the control disc blocks, in particular all, the through-channels.

Also preferably, the control disc is rotatable incrementally by the adjustment element and comprises, in the direction of rotation, at least 4, in particular 8 or 10, preferably at least 16 rotational positions in order to open up and/or block the through-channels. Here, it is advantageous that the damper valve is usable for different areas of application as a result of a variable number of rotational positions. Particularly preferably, the control disc is able to be moved into 10 or 16 rotational positions. It is also advantageous that a multiplicity of different rotational positions allow improved settability of the damping.

In a further preferred embodiment, the number of rotational positions of the control disc corresponds to the square of the number of opening areas of the recesses in the valve body. If the valve body has, for example, four recesses with different opening areas, the control disc is able to be moved into 16 rotational positions. Since the preferably four recesses in the valve body have different opening areas, the total opening area can be changed in 16 rotational positions of the control disc. In the following table, by way of example, 16 rotational positions are illustrated, wherein four different opening areas are settable for forming a total opening area by the blocking or opening up of four through-channels in the valve body. The total opening area corresponds in this case to the pressurized area of the valve disc during operation of the damper valve. The area values are given in square millimetres (mm2).

| Rotational | Opening | Opening | Opening | Opening | Total |
|---|---|---|---|---|---|
| position | area 1 | area 2 | area 3 | area 4 | opening area |
| 1 | | | | | 0 |
| 2 | 2 | | | | 2 |
| 3 | | 4 | | | 4 |
| 4 | 2 | 4 | | | 6 |
| 5 | | | 8 | | 8 |
| 6 | 2 | | 8 | | 10 |
| 7 | | 4 | 8 | | 12 |
| 8 | 2 | 4 | 8 | | 14 |
| 9 | | | | 16 | 16 |
| 10 | 2 | | | 16 | 18 |
| 11 | | 4 | | 16 | 20 |
| 12 | 2 | 4 | | 16 | 22 |
| 13 | | | 8 | 16 | 24 |
| 14 | 2 | | 8 | 16 | 26 |
| 15 | | 4 | 8 | 16 | 28 |
| 16 | 2 | 4 | 8 | 16 | 30 |

In a preferred embodiment, at least one of the recesses has an opening area which is larger than an inlet area of the through-channel leading into the recess. It is advantageous when all the through-channels have an inlet area, facing the respective recess, which is smaller than the opening area. The through-channels take up less space in the valve body as a result. The larger opening area makes it easier for the valve disc to lift off or open.

In one embodiment, at least two of the through-channels in the valve body have inlet areas with different flow cross sections. This is advantageous since, in addition to the area effect, a flow effect is also exploited by a smaller/larger flow cross section in order to actuate the valve disc.

In a further preferred embodiment, at least one or more of the recesses is/are in the form of a pocket and extend(s) in a radial direction. At least one or more of the recesses may extend in an annular manner in a radial direction. In other words, at least one or more of the recesses may extend in the circumferential direction of the valve body. The recesses and thus the opening areas in the valve body are thus designed in a space-saving manner as a result.

Preferably, the valve body has at least one shoulder which adjoins the recesses and into which the valve disc is inserted. Particularly preferably, the valve disc is received in the valve body, in particular arranged in an integrated manner. As a result, the damper valve is designed in an even more compact manner.

The control disc is preferably preloaded against the valve body by at least one spring element, in particular a volute spring and/or a cup spring. This serves to secure the position of the control disc. The control disc lies optimally against the valve body as a result. Furthermore, as a result, the control disc can lie closely against the valve body, this increasing the functional reliability.

The valve disc may be pressed against the valve body by at least one spacer. It is possible for the valve disc, additionally or alternatively, to be preloaded against the valve body by a screw connection. Both variants have the advantage that the valve disc is pressed against a valve disc seat of the valve body and thus allows, in the unactuated state, close abutment and, in the actuated state, that is to say in the open state, resetting of the valve disc.

The damper valve comprises preferably at least one actuating part, which is connected to the adjustment element for conjoint rotation, wherein the actuating part is accessible from the outside and is preferably rotatable by hand. This has the advantage that no overloading of and thus no damage to the adjustment mechanism, for example through incorrect operation of a tool, can occur. This increases the lifetime of the adjustment mechanism. Furthermore, easy and precise setting of the damping by hand is allowed.

The adjustment element may be in the form of an adjustment shaft which extends through the valve body and the control disc, wherein the control disc is arranged on the adjustment shaft for conjoint rotation and the valve body is rotationally decoupled from the adjustment shaft. The damper valve may additionally have at least one holding part, into which the valve body is at least partially inserted, in particular pressed, wherein the adjustment element extends through the holding part. Particularly preferably, the holding part forms a counter bearing for the spacer, in order to preload the valve disc against the valve body. The holding part serves both for fixedly receiving the valve body and for rotatably mounting the adjustment shaft and thus fulfils an advantageous dual function.

It is advantageous when the valve body has a multiplicity of return-flow channels which pass through the valve body and are arranged in a manner distributed in the circumferential direction. Particularly preferably, the return-flow channels are formed in the region of the circumference of the valve body. The return-flow channels may be open on the valve-disc side, on one side, and covered by the control disc on the other side. Preferably, the control disc and/or the valve disc are designed in a resilient manner. The return-flow channels are preferably covered flexibly by the control disc. In other words, the control disc fulfils a non-return function, wherein the control disc blocks the flow of the damper fluid in the damping direction and enables it counter to the damping direction. As a result of functional integration, the structure of the damper valve is simplified.

According to an additional independent aspect, some embodiments relate to a vibration damper for a motor vehicle, having at least one damper valve as described herein, wherein the damper valve is fluidically connected or is able to be fluidically connected to at least one working space and/or a compensation space of the vibration damper in order to set a damping force.

For the advantages of the vibration damper, reference is made to the advantages explained in connection with the damper valve. Furthermore, the vibration damper may, alternatively or additionally, have individual features or a combination of several features that are mentioned above in relation to the damper valve.

Some embodiments are explained in more detail in the following text by way of further details with reference to the attached drawings. The illustrated exemplary embodiment represents an example of how the damper valve described herein can be configured.

In the following text, the same reference signs will be used for identical or identically acting parts.

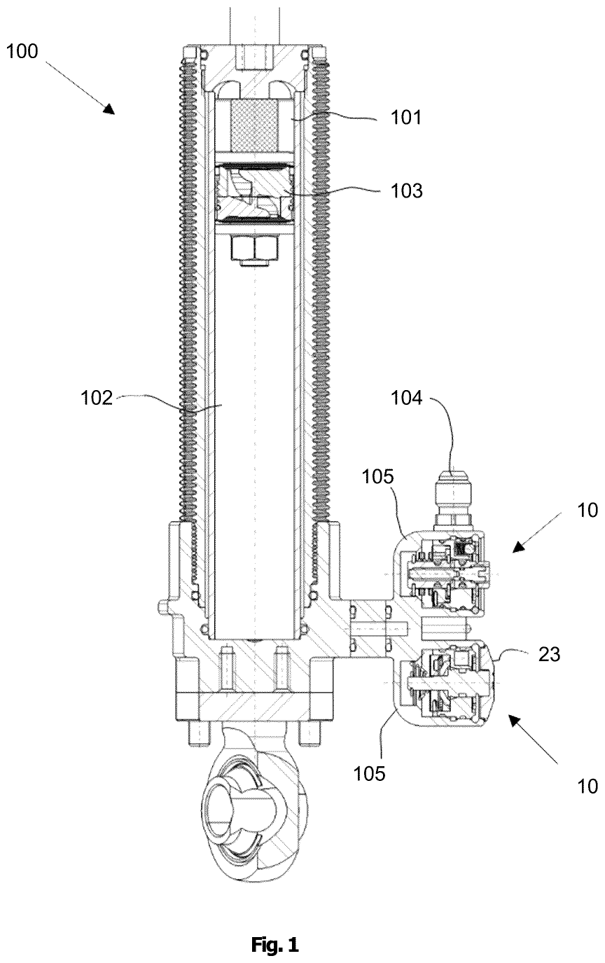

FIG. 1 shows a vibration damper 100 having two damper valves 10 according to one exemplary embodiment, wherein the damper valves 10 serve for rebound-stage and pressure-stage damping. In addition, the vibration damper 100 may have two further damper valves, which, for example, are not illustrated. The two damper valves 10 shown in FIG. 1 serve for rebound-stage and pressure-stage damping in the high-speed range. By contrast, the two further damper valves serve for rebound-stage and pressure-stage damping in the low-speed range. The vibration damper 100 is preferably used in motor vehicles. Particularly preferably, the vibration damper 100 is used for motorsports vehicles, in particular for racing cars or sportscars. Other areas of application are possible.

According to FIG. 1, the vibration damper 100 has a first working space 101 and a second working space 102, which are separated from one another by a working piston 103. The working spaces 101, 102 are filled with a damper fluid, in particular hydraulic oil. In addition, there is also a compensation space (not illustrated) for receiving and discharging at least a portion, corresponding to the piston-rod volume, of the damper fluid. The compensation space is provided on the outside, i.e. externally, and is able to be connected to one or both damper valves 10 via a connection 104. The damper valves 10 are fluidically connected to the working spaces 101, 102 such that the first damper valve 10 damps the rebound stage and the second damper valve 10 damps the pressure stage. The two damper valves 10 are arranged on the outside of the vibration damper 10, preferably one above the other.

In the rebound stage, preferably a bypass between the working spaces 101, 102 is opened up via the damper valves 10, such that the damper fluid, in addition to the main flow, flows through the damper valves 10 via a piston valve of the working piston 103. In the process, the damper fluid flows from the first working space 101, 102 into the second via one of the damper valves 10, such that the fluid flow is damped. The portion of the damper fluid that corresponds to the plunging piston-rod volume flows, in the process, out of the compensation space and into the working space 102. In this situation, rebound-stage damping is effected by the damper valve 10.

In the pressure stage, damper fluid flows mainly from the second working space 101, 102 into the first via the piston valve of the working piston 103. The portion of the damper fluid that corresponds to the plunging piston-rod volume flows out of the second working space 102 and into the external compensation space via one of the damper valves 10 and, in the process, is damped by the damper valve 10. In this situation, pressure-stage damping is thus effected by the damper valve 10.

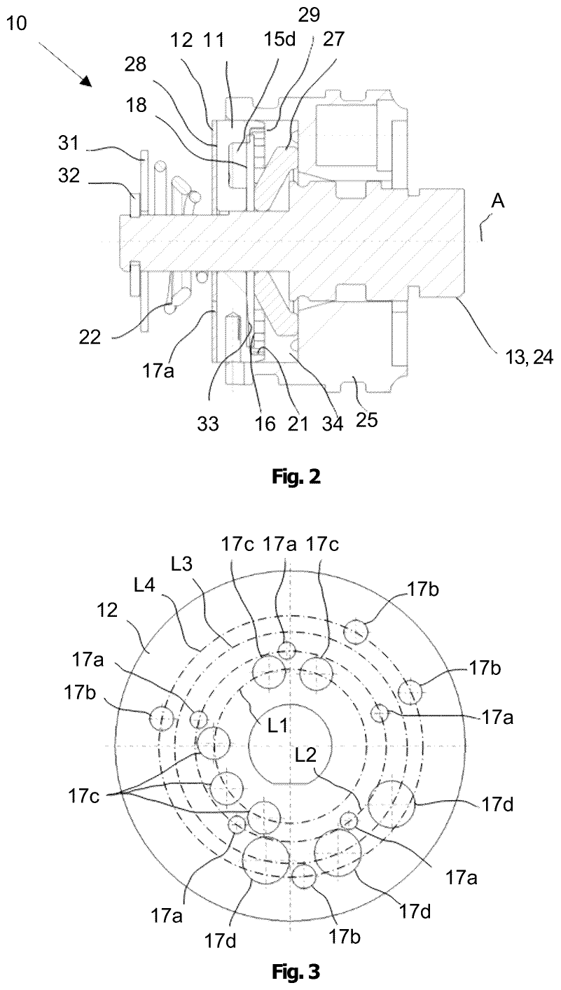

In the following text, the structure and the function of the two damper valves 10 will be described on the basis of one of the valves 10 with reference to FIGS. 2 to 13.

FIG. 2 shows a longitudinal section through one of the damper valves 10. The damper valve 10 has a valve body 11, a control disc 12 arranged on the valve body 11, and a rotatably mounted adjustment element 13. Furthermore, the damper valve 10 has a valve disc 16, which is likewise arranged on the valve body 11. The valve body 11, the control disc 12, the adjustment element 13 and the valve disc 16 are arranged coaxially. In other words, the valve body 11, the control disc 12, the adjustment element 13 and the valve disc 16 lie on a common axis A. The control disc 12 is connected to the adjustment element 13 for conjoint rotation, wherein the control disc 12 is rotatable relative to the valve body 11. In other words, the control disc 12 is mounted so as to be rotatable about the axis A by the adjustment element 13. The control disc 12 is connected to the adjustment element 13 with a form fit. It is apparent from FIGS. 2 and 4-13 that the control disc 12 and the adjustment element 13 are coupled via a simple connection. Other types of connection are possible. The valve body 11 and the valve disc 16 are stationary. In other words, the valve body 11 and the valve disc 16 are provided in a non-rotatable manner.

As can be seen in FIG. 2, the valve body 11 has a first side 28 against which the control disc 12 lies. Furthermore, the valve body 11 has a second side 29, which is on the opposite side from the first. The valve disc 16 lies against the second side 29. On the second side 29, the valve body 11 comprises a shoulder 21, wherein the valve disc 16 is arranged in the shoulder 21. In other words, the valve disc 16 has been inserted into the valve body 11. Or, put another way, the valve disc 16 is arranged in an integrated manner in the valve body 11. The valve disc 16 will be discussed in more detail below.

FIG. 2 furthermore shows that the control disc 12 lies closely against the first side 28, which is formed in a flat manner. This is achieved in that the control disc 12 is preloaded against the first side 28 of the valve body 11 by a spring element 22. The spring element 22 is a volute spring in the present case. Alternatively, the spring element 22 may be one or more cup springs. Other types of spring are possible.

The spring element 22 is supported on a supporting element 31 which is spaced apart from the control disc 12 along the axis A. The supporting element 31 lies against a part 32 which is connected to the adjustment element 13 and forms a counter bearing for the supporting element 31.

As is apparent from FIGS. 4 to 13, the valve body 11 comprises a plurality of through-channels 14a-14d, which pass through the valve body 11. The through-channels 14a-14d each form a free passage from the first side 28, 29 of the valve body 11 to the second. The through-channels 14a-14d are in the form of bores.

Furthermore, the valve body 11 has a multiplicity of return-flow channels 26, which pass through the valve body 11 and are arranged in a uniformly distributed manner in the circumferential direction. The return-flow channels 26 connect the two sides 28, 29 of the valve body 11. On the first side 28, in particular on the control-disc side, the return-flow channels 26 are covered by the control disc 12. In order, in a return-flow situation, to ensure that the channels 26 are opened, the control disc 12 is formed in a resilient manner. The control disc 12 thus acts, in addition to the switching function, as a non-return disc for the returning damper fluid flow.

Furthermore, it is apparent from FIGS. 4-13 that the valve body 11 has a plurality of recesses 15a-15d, wherein in each case one of the through-channels 14a-14d leads into one of the recesses 15a-15d. The recesses 15a-15d are formed in a recessed manner in the valve body 11. Specifically, the valve body 11 has four recesses 15a-15d and four through-channels 14a-14d. Thus, one through-channel 15a-15d is formed per recess 15a-15d, in order to allow a flow of the damper fluid.

As shown in FIG. 2, the recesses 15a-15d are formed in an integrated manner in the valve body 11. Specifically, the recesses 15a-15d are formed, starting from a disc support 33 of the valve body 11, in the direction of the first side 28 of the valve body 11. The recesses 15a-15d form pockets and are open towards the valve disc 16. In other words, the recesses 15a-15d are formed in an open manner in the direction of the second side 29 of the valve body 11. The recesses 15a-15d extend in a radial direction and partially in the circumferential direction of the valve body 11. In other words, the recesses 15a-15d are formed in an annular manner. Or, put another way, the recesses 15a-15d form an annular, recessed portion in the valve body 11. The recesses 15a-15d are arranged successively and in a manner spaced apart from one another in the circumferential direction. The recesses 15a-15d are arranged in a distributed manner about the axis A.

As is shown in FIGS. 4-13, the opening area 18 of the first recess 15a is smaller than the opening area 18 of the second recess 15b. Furthermore, the opening area 18 of the second recess 15b is smaller than the opening area 18 of the third recess 15c. In addition, the opening area 18 of the third recess 15c is smaller than the opening area 18 of the fourth recess 15d. The fourth recess 15d has the largest opening area 18.

It can be seen in FIG. 2 that the valve disc 16 completely spans, in particular covers, the recesses 15a-15d. It is apparent from FIGS. 4-13 that the recesses 15a-15d have different opening areas 18. The opening areas 18 correspond to those extensive openings of the recesses 15a-15d that face the valve disc 16. The opening areas 18 are directly covered by the valve disc 16, in particular in the unactuated state.

It is also apparent from the figures that each opening area 18 of the recesses 15a-15d is larger than an inlet area 19 of the through-channel 14a-14d leading into the recess 15a-15d. It is likewise apparent that the through-channels 14a-14d have different inlet areas 19. In other words, the through-channels 14a-14d have different flow cross sections.

The through-channels 14a-14d are able to be selected by the control disc 12. This means that the through-channels 14a-14d can be opened up or blocked by rotating the control disc 12. The through-channels 14a-14d in the valve body 11 are able to be selected and/or blocked by the control disc 12 in such a way that, for example, in a first direction of rotation of the control disc 12, the opening areas 18 of the recesses 15a-15d are added together or, for example, in a second, opposite, direction of rotation of the control disc 12, the opening areas of the recesses 15a-15d are subtracted from one another.

To this end, the control disc 12 has a plurality of openings 17a-17d for each through-opening 14a-14d in the valve body 11, wherein, depending on the rotational position of the control disc 12, one or more of the through-channels 14a-14d are opened up by the openings 17a-17d or the through-channels 14a-14d are blocked by the control disc 12. This is clear from FIG. 3. Furthermore, it is apparent from FIG. 3 that the openings 17a-17d are arranged on different hole circles L1-L4. The same goes for the through-channels 14a-14d in the valve body 11.

In the following text, the position of the openings 17a-17d in the radial direction from inside to outside is explained. The openings 17c in the control disc 12 for a third through-channel 14c in the valve body 11 are arranged on a first hole circle L1. The third through-channel 14c leads into the third recess 15c. The openings 17a in the control disc 12 for a first through-channel 14a in the valve body 11 are arranged on a second hole circle L2. The first through-channel 14a leads into the first recess 15a. The openings 17d in the control disc 12 for a fourth through-channel 14d in the valve body 11 are arranged on a third hole circle L3. The fourth through-channel 14d leads into the fourth recess 15d. The openings 17b in the control disc 12 for a second through-channel 14b in the valve body 11 are arranged on a fourth hole circle L4. The second through-channel 14b leads into the second recess 15b. Consequently, the through-channels 14a-14d are also arranged on the different hole circles in order to correspond to the associated openings 17a-17d in the control disc 12. The different interconnections will be discussed in detail below.

According to FIG. 2, the recesses 15a-15d border the shoulder 21. The disc support 33 serves to support the valve disc 16 and is arranged at the transition between the recesses 15a-15d and the shoulder 21. The disc support 33 is a supporting surface for the sealing support of the valve disc 16.

As can be seen in FIG. 2, the valve disc 16 lies on the disc support 33. This corresponds to the unactuated state of the valve disc 16, in which no damper fluid flows through the through-channels 14a-14d. This may be the case when all the through-channels 14a-14d are blocked by the control disc 12 or the vibration damper 100 is in the rest state. In the unactuated state, the valve disc 16 completely covers or closes the recesses 15a-15d.

Not illustrated is the actuated state of the valve disc 16, in which damper fluid flows through one or more of the through-channels 14a-14d into the recesses 15a-15d and thus lifts the valve disc 16 off the disc support 33. In this case, the control disc 12 is in a rotational position in which it opens up the one or more through-channels 14a-14d.

The valve disc 16 is designed in a resilient manner in order to realize lifting off from the disc support 33 and automatic resetting. FIG. 2 shows that the valve disc 16 is pressed against the valve body 11 by a spacer 27 in a radially inner position. Starting from this position, the valve disc 16 is deformable in a radially outwardly flexible, i.e. elastic manner.

According to FIG. 2, the damper valve 10 has a holding part 25, which comprises a receptacle 34 for the valve body 11. The valve body 11 is pressed partially into the receptacle 34 of the holding part 25 on the front side. The valve body 11 is thus connected to the holding part 25 for conjoint rotation. The holding part 25 is, in turn, arranged in a valve housing 105 of the vibration damper 100 (see FIG. 1). As can be seen in FIG. 2, the spacer 27 is supported against a face, forming a counter bearing, of the holding part 25. Specifically, the spacer 27 is supported against a bottom of the receptacle 34 of the holding part 25. The spacer 27 is a rigid element. Preferably, the spacer 27 is conical and extends around the adjustment element 13.

As a result of the press connection of the valve body 11 and holding part 25, the spacer 27 is thus pressed against the receptacle bottom of the holding part 25 and thus preloads the valve disc 16 against the disc support 33 of the valve body 11. In order to fix the valve body 11 in its position, the valve body 11 and the holding part 25 have a radially extending bore. Into the latter, a fixing means (not illustrated), in particular a grub screw, is able to be introduced in order to establish a force- and/or form-fitting connection between the valve body 11 and the holding part 25.

It is likewise apparent from FIG. 2 that the adjustment element 13 is mounted rotatably in the holding part 25. The adjustment element 13 extends through the holding part 25, wherein the adjustment element 13 is arranged partially in the holding part 25. The holding part 25 secures the position of the adjustment element 13 in the longitudinal direction, i.e. on the axis A. The adjustment element 13 is in the form of a shaft and can therefore also be referred to as an adjustment shaft 24. The adjustment shaft 24 extends through the valve body 11 and the control disc 12, wherein the control disc 12 is arranged on the adjustment shaft 24 for conjoint rotation and the valve body 11 is rotationally decoupled from the adjustment shaft 24.

It is apparent from FIG. 1 that the damper valve 10 has an actuating part 23 which is connected to the adjustment shaft 24 for conjoint rotation. The actuating part 23 is accessible from the outside and rotatable by hand. It is apparent that the actuating part 23 is a handwheel in the form of a sleeve attached to the adjustment shaft 24.

In the following text, with reference to FIGS. 4-13, the different rotational positions of the control disc 12 are described in relation to the changing total opening area or pressurized area of the valve disc 16. Specifically, FIGS. 4-13 show a total of 10 switching positions of the damper valve 10, wherein the control disc 12 is rotated, starting from a first rotational position (see FIG. 4), in the anticlockwise direction. In the process, the damping is adjusted incrementally from hard to soft in FIGS. 4-13. The rotational positions of the control disc 12 are set in a defined rotational angle pattern. In the present case, the control disc 12 is rotated by the adjustment shaft 24 in each case through 36° about the axis A from one rotational position to the next. This allows incremental adjustment. Other angular increments are possible.

In FIGS. 4-13, the control disc 12 is concealed by the valve body 11. The valve disc 16 and all the other components are hidden for better illustration of the switching positions. The dashed lines in FIGS. 4-13 are necessary in order to identify the rotational position of the overlaid control disc 12.

FIG. 4 thus shows a first rotational position, in which the control disc 12 is blocking all four through-channels 14a-14d such that no damper fluid can flow into the recesses 15a-15d and the valve disc 16 remains on the disc support 33. On the first side 28 of the valve body 11, the through-channels 14a-14d are thus completely covered by the control disc 12. This corresponds to the hardest damping setting of the damper valve 10. In the first rotational position, the total opening area and thus the pressurized area of the valve disc 16 is equal to zero.

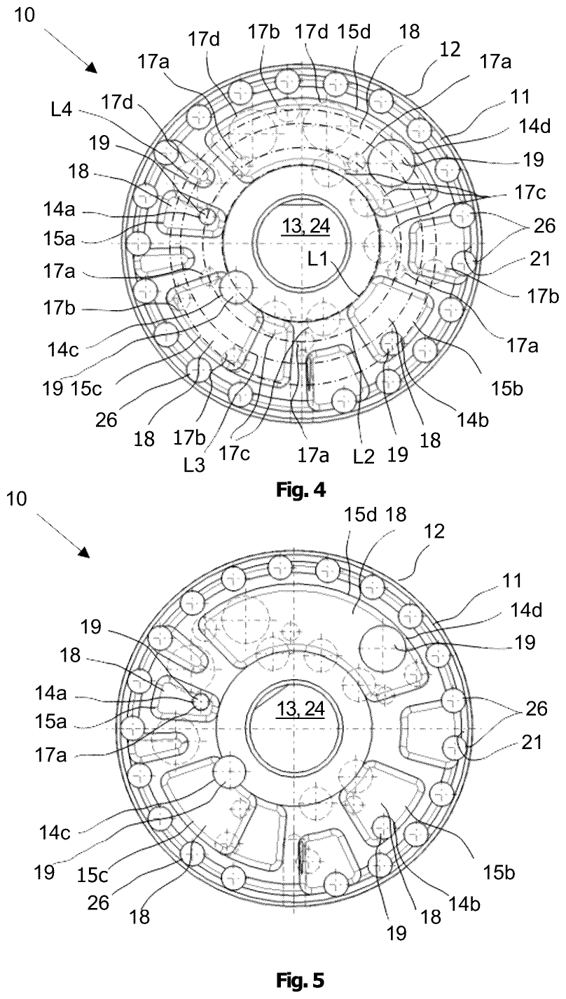

In FIG. 5, the control disc 12 has been rotated anticlockwise through 36° about the axis A. Here, the control disc 12 is in a second rotational position, in which one of the first openings 17a in the control disc 12 coincides with the first through-channel 14a and opens up the latter as a result.

During operation, damper fluid flows through the first through-channel 14a into the first recess 15a, which has a first opening area 18 of 2 mm2. The pressurized area of the valve disc 16 thus also corresponds to 2 mm2. During operation, the damper fluid thus flows into the first recess 15a and lifts the valve disc 16 off the disc support 33 at least at the location of the first recess 15a. This corresponds to very hard damping.

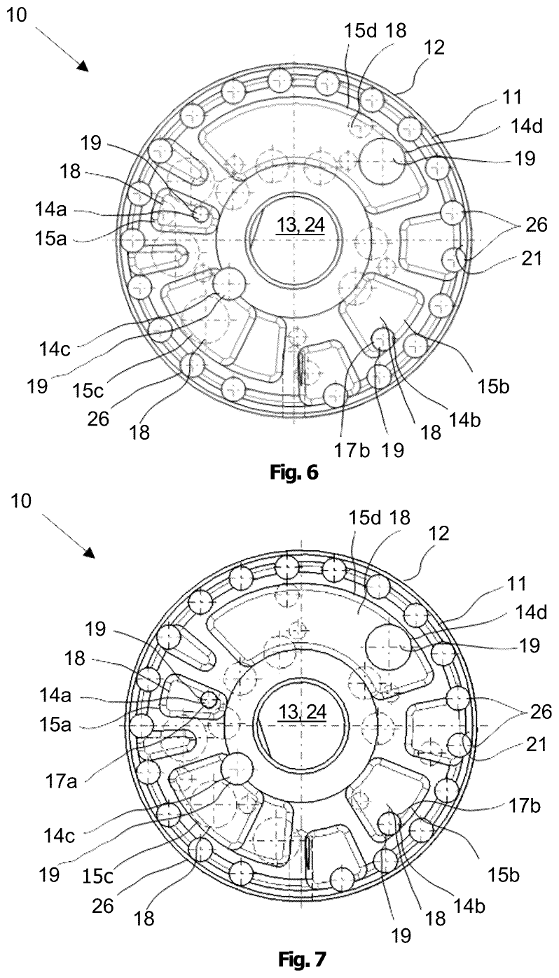

In FIG. 6, the control disc 12 has been rotated anticlockwise, with respect to the second rotational position of the control disc 12, through 36° about the axis A. Here, the control disc 12 is in a third rotational position, in which one of the second openings 17b in the control disc 12 coincides with the second through-channel 14b and opens up the latter as a result. During operation, damper fluid flows through the second through-channel 14b into the second recess 15b, which has a second opening area 18 of 4 mm2. The pressurized area of the valve disc 16 thus also corresponds to 4 mm2. As a result, the damping is set at a somewhat softer level than in the second rotational position of the control disc 12.

In FIG. 7, the control disc 12 has been rotated anticlockwise, with respect to the third rotational position of the control disc 12, through 36° about the axis A. Here, the control disc 12 is in a fourth rotational position, in which one of the first openings 17a coincides with the first through-channel 14a and one of the second openings 17b in the control disc 12 coincides with the second through-channel 14b and both channels 14a, 14b are opened up as a result. During operation, damper fluid flows through the two through-channels 14a, 14b into the two recesses 15a, 15b, such that the opening areas 18 thereof (2 mm2 and 4 mm2) are added together to form a total opening area of 6 mm2. The pressurized area of the valve disc 16 thus also corresponds to 6 mm2. As a result, the damping is set at a somewhat softer level than in the third rotational position of the control disc 12.

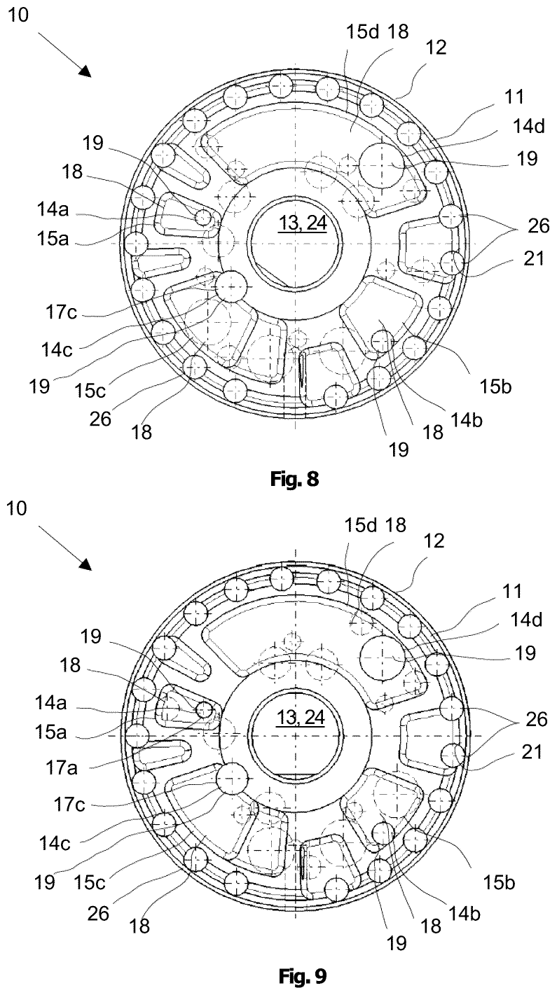

In FIG. 8, the control disc 12 has been rotated anticlockwise, with respect to the fourth rotational position of the control disc 12, through 36° about the axis A. Here, the control disc 12 is in a fifth rotational position, in which one of the third openings 17c in the control disc 12 coincides with the third through-channel 14c and opens up the latter as a result. During operation, damper fluid flows through the third through-channel 14c into the third recess 15c, which has a third opening area 18 of 8 mm2. The pressurized area of the valve disc 16 thus also corresponds to 8 mm2. As a result, the damping is set at a somewhat softer level than in the fourth rotational position of the control disc 12.

In FIG. 9, the control disc 12 has been rotated anticlockwise, with respect to the fifth rotational position of the control disc 12, through 36° about the axis A. Here, the control disc 12 is in a sixth rotational position, in which one of the first openings 17a coincides with the first through-channel 14a and one of the third openings 17c in the control disc 12 coincides with the third through-channel 14c and both channels 14a, 14c are opened up as a result. During operation, damper fluid flows through the two through-channels 14a, 14c into the two recesses 15a, 15c, such that the opening areas 18 thereof (2 mm2 and 8 mm2) are added together to form a total opening area of 10 mm2. The pressurized area of the valve disc 16 thus also corresponds to 10 mm2. As a result, the damping is set at a somewhat softer level than in the fifth rotational position of the control disc 12.

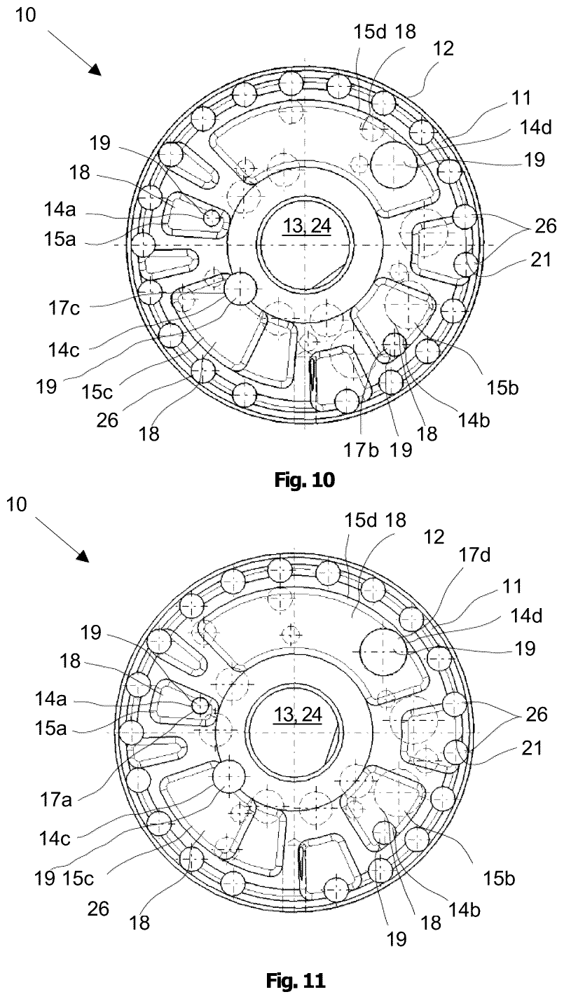

In FIG. 10, the control disc 12 has been rotated anticlockwise, with respect to the sixth rotational position of the control disc 12, through 36° about the axis A. Here, the control disc 12 is in a seventh rotational position, in which one of the second openings 17b coincides with the second through-channel 14b and one of the third openings 17c in the control disc 12 coincides with the third through-channel 14c and both channels 14b, 14c are opened up as a result. During operation, damper fluid flows through the two through-channels 14b, 14c into the two recesses 15b, 15c, such that the opening areas 18 thereof (4 mm2 and 8 mm2) are added together to form a total opening area of 12 mm2. The pressurized area of the valve disc 16 thus also corresponds to 12 mm2. As a result, the damping is set at a somewhat softer level than in the sixth rotational position of the control disc 12.

In FIG. 11, the control disc 12 has been rotated anticlockwise, with respect to the seventh rotational position of the control disc 12, through 36° about the axis A. Here, the control disc 12 is in an eighth rotational position, in which one of the first openings 17a coincides with the first through-channel 14a and one of the fourth openings 17d in the control disc 12 coincides with the fourth through-channel 14d and both channels 14a, 14d are opened up as a result. During operation, damper fluid flows through the two through-channels 14a, 14d into the two recesses 15a, 15d, such that the opening areas 18 thereof (2 mm2 and 16 mm2) are added together to form a total opening area of 18 mm2. The pressurized area of the valve disc 16 thus also corresponds to 18 mm2. As a result, the damping is set at a somewhat softer level than in the seventh rotational position of the control disc 12.

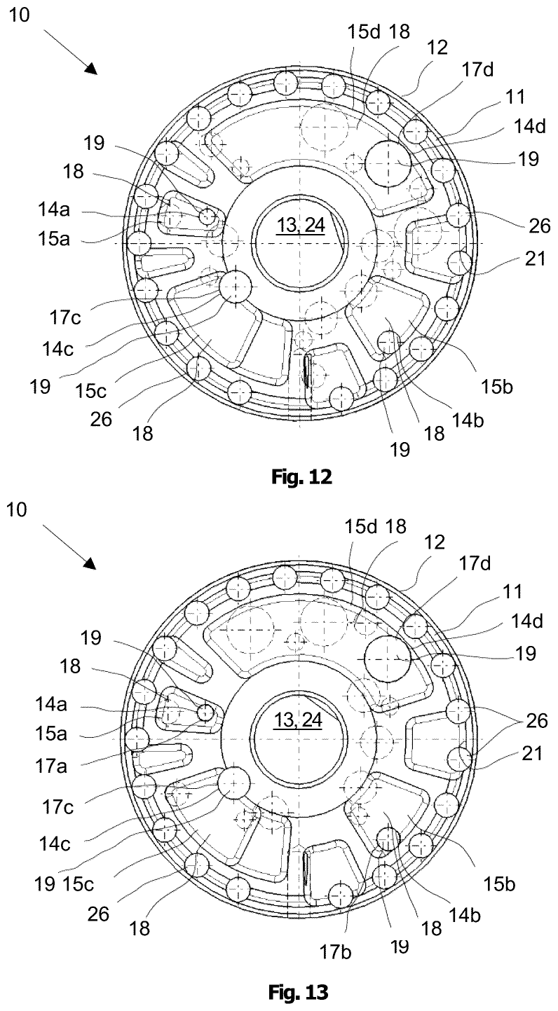

In FIG. 12, the control disc 12 has been rotated anticlockwise, with respect to the eighth rotational position of the control disc 12, through 36° about the axis A. Here, the control disc 12 is in a ninth rotational position, in which one of the second openings 17b coincides with the second through-channel 14b and one of the fourth openings 17d in the control disc 12 coincides with the fourth through-channel 14d and both channels 14b, 14d are opened up as a result. During operation, damper fluid flows through the two through-channels 14b, 14d into the two recesses 15b, 15d, such that the opening areas 18 thereof (4 mm2 and 16 mm2) are added together to form a total opening area of 20 mm2. The pressurized area of the valve disc 16 thus also corresponds to 20 mm2. As a result, the damping is set at a somewhat softer level than in the eighth rotational position of the control disc 12.

In FIG. 13, the control disc 12 has been rotated anticlockwise, with respect to the ninth rotational position of the control disc 12, through 36° about the axis A. Here, the control disc 12 is in a tenth rotational position, in which one of the first openings 17a coincides with the first through-channel 14a, one of the second openings 17b coincides with the second through-channel 14b, one of the third openings 17c in the control disc 12 coincides with the third through-channel 14c and one of the fourth openings 17d coincides with the fourth through-channel 14d and all four channels 14a-14d are opened up as a result. During operation, damper fluid flows through the four through-channels 14a-14d into all four recesses 15a-15d, such that the opening areas 18 thereof (2 mm2, 4 mm2, 8 mm2 and 16 mm2) are added together to form a total opening area of 30 mm2. The pressurized area of the valve disc 16 thus also corresponds to 30 mm2. As a result, the damping is set at a somewhat softer level than in the ninth rotational position of the control disc 12. This rotational position of the control disc 12 brings about the softest damping.

It should be noted that the number of openings in the control disc 12, the number of through-channels in the valve body 11 and the number of recesses with different opening areas is not limited to the number shown in FIGS. 3-13. Some embodiments can, in different configurations, comprise more or fewer openings, recesses and opening areas. It is thus possible to provide more or fewer than 10 rotational positions and thus switching positions of the damper valve 10. This allows a high level of variability in production and in use of the damper valve 10 described herein.

### LIST OF REFERENCE SIGNS

10 Damper valve
11 Valve body
12 Control disc
13 Adjustment element
14a-14d Through-channels
15a-15d Recess
16 Valve disc
17a-17d Openings in the control disc
18 Opening areas of the recesses
19 Inlet area of the through-channel
21 Shoulder
22 Spring element
23 Actuating part
24 Adjustment shaft
25 Holding part
26 Return-flow channels
27 Spacer
28 First side of the valve body
29 Second side of the valve body
31 Supporting element
32 Part connected to the adjustment element
33 Disc support
34 Receptacle
100 Vibration damper
101 First working space
102 Second working space
103 Working piston
104 Connection for the compensation space
105 Valve housing
L1-L4 Hole circles
A Axis

1. A damper valve for a vibration damper, comprising:
a valve body;
at least one control disc arranged on the valve body; and
at least one rotatably mounted adjustment element;
wherein the valve body, the control disc and the adjustment element are arranged coaxially;
wherein the control disc is connected to the adjustment element for conjoint rotation and the control disc is rotatable relative to the valve body in order to open up at least one of a plurality of through-channels in the valve body for the flow of a damper fluid or to block the flow;
wherein the valve body has a plurality of recesses with different opening areas which are covered by at least one valve disc;
wherein in each case one through-channel leads into in each case one of the recesses.

2. The damper valve according to claim 1, wherein the through-channels in the valve body are able to be selected and/or blocked by the control disc in such a way that, in at least one direction of rotation of the control disc, the opening areas of the recesses are added together or subtracted from one another.

3. The damper valve according to claim 1, wherein the control disc has a plurality of openings for each through-channel in the valve body, wherein, depending on a rotational position of the control disc, one or more of the through-channels are opened up by the openings or the control disc blocks the through-channels.

4. The damper valve according to claim 3, wherein the openings in the control disc and/or the through-channels in the valve body are arranged on different hole circles.

5. The damper valve according to claim 4, wherein the openings in the control disc and the through-channel in the valve body which lie on the same hole circle correspond or are spaced apart from one another depending on the rotational position of the control disc.

6. The damper valve according to claim 1, wherein the control disc is rotatable incrementally by the adjustment element and comprises, in the direction of rotation, at least 4, in particular 8 or 10, preferably at least 16 rotational positions in order to open up and/or block the through-channels.

7. The damper valve according to claim 1, wherein at least one of the recesses has an opening area which is larger than an inlet area of the through-channel leading into the recess.

8. The damper valve according to claim 1, wherein at least two of the through-channels in the valve body have inlet areas with different flow cross sections.

9. The damper valve according to claim 1, wherein at least one or more of the recesses is/are in the form of a pocket and extend(s) in a radial direction.

10. The damper valve according to claim 1, wherein at least one or more of the recesses extend in an annular manner in a radial direction.

11. The damper valve according to claim 1, wherein the valve body has at least one shoulder which adjoins the recesses and into which the valve disc is inserted.

12. The damper valve according to claim 1, wherein the control disc is preloaded against the valve body by at least one spring element, in particular a volute spring and/or a cup spring.

13. The damper valve according to claim 1, wherein the valve disc is pressed against the valve body by at least one spacer.

14. The damper valve according to claim 1, wherein at least one actuating part is connected to the adjustment element for conjoint rotation, wherein the actuating part is accessible from the outside and is preferably rotatable by hand.

15. The damper valve according to claim 1, wherein the adjustment element is in the form of an adjustment shaft which extends through the valve body and the control disc, wherein the control disc is arranged on the adjustment shaft for conjoint rotation and the valve body is rotationally decoupled from the adjustment shaft.

16. The damper valve according to claim 1, wherein at least one holding part is provided, into which the valve body is at least partially inserted, wherein the adjustment element extends through the holding part.

17. The damper valve according to claim 1, the valve body has a multiplicity of return-flow channels which pass through the valve body and are arranged in a manner distributed in the circumferential direction.

18. The damper valve according to claim 17, wherein the return-flow channels are open on the valve-disc side, on one side, and covered by the control disc on the other side.

19. The damper valve according to claim 1, wherein the control disc and/or the valve disc are designed in a resilient manner.

20. A vibration damper for a motorized vehicle, having at least one damper valve according to claim 1, wherein the damper valve is fluidically connected or is able to be fluidically connected to at least one working space and/or a compensation space of the vibration damper in order to set a damping force.
